(19) United States
(12) Patent Application Publication
(10) Pub. No.: US 2018/0355222 A1
(43) Pub. Date: Dec. 13, 2018

(54) METHOD OF COATING A CONDUCTIVE ADHESIVE ON AN ARRAY SUBSTRATE, A COATING ADHESIVE DEVICE, AND A COATING ADHESIVE SYSTEM

(71) Applicants: HKC Corporation Limited, Shenzhen (CN); Chongqing HKC Optoelectronics Technology Co., ltd., Chongqing (CN)

(72) Inventor: CHUNG-KUANG CHIEN, Chongqing (CN)

(21) Appl. No.: 15/848,699

(22) Filed: Dec. 20, 2017

Related U.S. Application Data
(63) Continuation of application No. PCT/CN2017/089668, filed on Jun. 23, 2017.

(30) Foreign Application Priority Data
Jun. 7, 2017 (CN) 201710425214.7

(51) Int. Cl. C09J 9/02; B05C 5/02; B05C 11/02

(52) U.S. Cl. CPC C09J 9/02; G02F 2202/16; B05C 11/023; B05C 5/02

(57) ABSTRACT

The present application provides a method of coating a conductive adhesive on an array substrate, a coating adhesive device, and a coating adhesive system. The coating adhesive device includes: a driver device; a container carrying a flowable conductive adhesive, including a lateral wall, an inlet on the lateral wall, a bottom, and an outlet on the bottom; and a firing pin disposed inside the container, reciprocating between a first position and a second position, wherein the outlet is clogged by the firing pin when the firing pin is at the first position, and the firing pin leaves the outlet and the flowable conductive adhesive flows out when the firing pin is at the second position.

### TECHNICAL FIELD

The present application relates to a manufacturing field, and more particularly, to a method of coating a conductive adhesive on an array substrate, a coating adhesive device, and a coating adhesive system.

### BACKGROUND OF RELATED ART

A conductive adhesive adopted by an LCD factory such as Anisotropic Conductive Film (ACF) is processed to be a package by a supplier. The package ACF needs to undergo processes such as glue mixing, dispensing, and cutting, and be packed and transported to the market. The LCD factory buys this package ACF from the market to adhere an array substrate and a driver IC system. This procedure results in that the costs of the ACF and a display panel are high.

### SUMMARY

The present application provides a method of coating a conductive adhesive on an array substrate, a coating adhesive device, and a coating adhesive system. It can reduce costs of manufacturing the conductive adhesive and the display panel.

First, an embodiment of the present application provides a coating adhesive device, including:

a driver device;

a container carrying a flowable conductive adhesive, including a lateral wall, an inlet on the lateral wall, a bottom, and an outlet on the bottom; and

a firing pin disposed inside the container, reciprocating between a first position and a second position,

wherein the outlet is clogged by the firing pin when the firing pin is at the first position, and the firing pin leaves the outlet and the flowable conductive adhesive flows out when the firing pin is at the second position.

The container includes an upper part and a lower part, and the upper part is a cylinder shape and the lower part is a funnel shape.

The firing pin includes a column and a needle, and the needle is a cone shape.

The upper part includes an inner wall, and diameter of the column is equal to that of the inner wall.

The inlet is located on the upper part, and a top of the firing pin is higher than the inlet when the firing pin is at the first position.

The flowable conductive adhesive from the outlet coats an array substrate along a default direction.

Second, an embodiment of the present application provides a coating adhesive system, including a moving device and a coating adhesive device, the coating adhesive device including:

a driver device;

a container carrying a flowable conductive adhesive, including a lateral wall, an inlet on the lateral wall, a bottom, and an outlet on the bottom; and

a firing pin disposed inside the container, reciprocating between a first position and a second position, wherein the outlet is clogged by the firing pin when the firing pin is at the first position, and the firing pin leaves the outlet and the flowable conductive adhesive flows out when the firing pin is at the second position;

wherein the moving device moves the coating adhesive device to coat the flowable conductive adhesive on an array substrate along a default direction.

Third, an embodiment of the present application provides a method of coating a conductive adhesive on an array substrate, including:

loading a flowable conductive adhesive in the coating adhesive device; and

pressing the flowable conductive adhesive from the coating adhesive device and coating the flowable conductive adhesive on the array substrate along a default direction.

After pressing the flowable conductive adhesive from the coating adhesive device and coating the flowable conductive adhesive along a default direction, it further includes curing the flowable conductive adhesive coated on the array substrate by ultraviolet.

Coating the flowable conductive adhesive on the array substrate along the default direction includes: moving the coating adhesive device along the default direction and coating the flowable conductive adhesive on the array substrate; or

moving the array substrate along a direction opposite to the default direction and coating the flowable conductive adhesive on the array substrate.

An embodiment of the present application provides a method of coating a conductive adhesive on an array substrate, a coating adhesive device, and a coating adhesive system. The coating adhesive device includes: a driver device; a container carrying a flowable conductive adhesive, including a lateral wall and an inlet on the lateral wall, and a bottom and an outlet on the bottom; and a firing pin disposed inside the container, reciprocating between a first position and a second position, wherein the outlet is clogged by the firing pin when the firing pin is at the first position, and the firing pin leaves the outlet and the flowable conductive adhesive flows out when the firing pin is at the second position. The present application does not form the conventional conductive adhesive which undergoes the processes such as dispensing and packaging, cutting, packing, and transportation in the market. It does not adhere the conventional conductive adhesive on the array substrate but directly coats the flowable conductive adhesive formed by mixing raw materials on the array substrate. It can reduce many processes and save cost.

### BRIEF DESCRIPTION OF THE DRAWINGS

The accompanying drawings are included to provide easy understanding of the application, are incorporated herein and constitute a part of this specification. The drawings illustrate embodiments of the application and, together with the description, serve to illustrate the principles of the application.

FIG. 1 is a flow chart of a method of coating a conductive adhesive on an array substrate in accordance with an embodiment of the present application.

FIG. 2 is another flow chart of a method of coating a conductive adhesive on an array substrate in accordance with an embodiment of the present application.

FIG. 3 is a structure schematic view of a coating adhesive device in accordance with an embodiment of the present application.

FIG. 4 is a structure schematic view of a coating adhesive device where a firing pin is at a first position in accordance with an embodiment of the present application.

FIG. 5 is a schematic view of a coating adhesive device where a firing pin is at a second position in accordance with an embodiment of the present application.

### DETAILED DESCRIPTION OF EMBODIMENTS

To better and concisely explain the disclosure, the same name or the same reference number given or appeared in different paragraphs or figures along the specification should has the same or equivalent meanings while it is once defined anywhere of the disclosure. In the case of no conflict, the following embodiments and the features thereof can be combined with each other.

It is understood that the terminology “include” and ‘comprise’ is to mean the existence of a feature, an entirety, a step, an operation, an element, and/or a composition in the specification and claims of the present application. It does not exclude the existence or the addition of a feature, an entirety, a step, an operation, an element, and/or a composition

Referring FIG. 1, FIG. 1 is a flow chart of a method of coating a conductive adhesive on an array substrate in accordance with an embodiment of the present application. The method includes following steps S101-S102:

S101: loading a flowable conductive adhesive in a coating adhesive device.

Further, the conductive adhesive can choose Anisotropic Conductive Film (ACF). Raw materials of ACF are resin, conductive particles, and curing agent. The raw materials are mixed to form the flowable conductive adhesive.

The conventional ACF is processed to be a package by a supplier. The package ACF needs to undergo processes such as glue mixing, dispensing, and cutting, and be packed and transported to the market. Coating adhesive on a display panel generally adopts this package ACF to adhere an array substrate and a driver IC system. This procedure results in that the costs of the ACF and the display panel are high.

In an embodiment of the present application, the raw materials are mixed to form the flowable conductive adhesive. This conductive adhesive is just modulated, does not undergo dispensing, and is flowable. The flowable conductive adhesive is loaded in the coating adhesive device and coated on corresponding areas of the array substrate.

S102: pressing the flowable conductive adhesive from the coating adhesive device and coating the flowable conductive adhesive on the array substrate along a default direction.

For example, it can coat the array substrate along a direction parallel to a scan line or a data line.

Further, the step S102 is particular to move the coating adhesive device along the default direction and coat the flowable conductive adhesive on the array substrate.

Or, the step S102 particular includes moving the array substrate along a direction opposite to the default direction and coating the flowable conductive adhesive on the array substrate.

In an embodiment of the present application, it can move the array substrate or the coating adhesive device to coat the flowable conductive adhesive on a position of the array substrate where needs the flowable conductive adhesive.

The method of coating a conductive adhesive on an array substrate in accordance with this embodiment of the present application is to directly coat the flowable conductive adhesive mixed by the raw materials on the array substrate. It can reduce many processes and save cost.

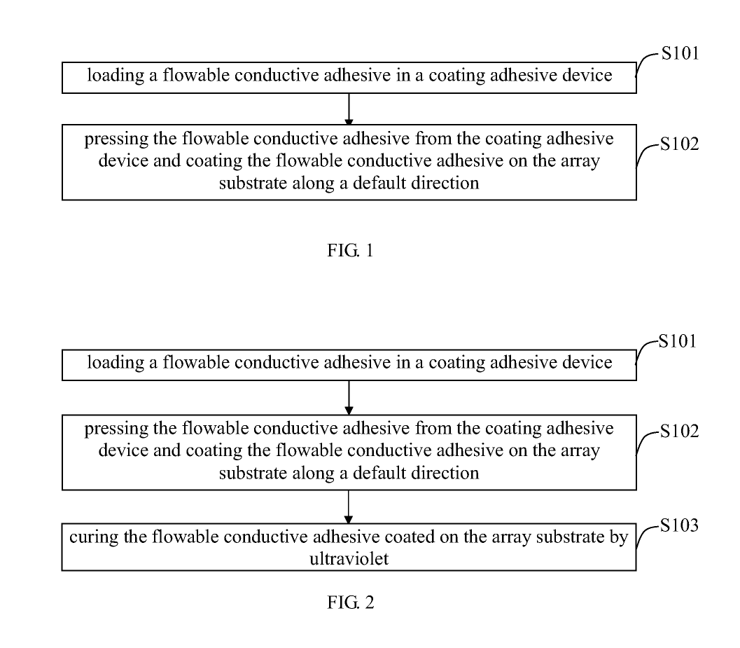

Referring FIG. 2, FIG. 2 is a flow chart of a method of coating a conductive adhesive on an array substrate in accordance with an embodiment of the present application. The method includes following steps S101-S103:

S101: loading a flowable conductive adhesive in a coating adhesive device.

S102: pressing the flowable conductive adhesive from the coating adhesive device and coating the flowable conductive adhesive on the array substrate along a default direction.

The conductive adhesive can ACF. Resin, conductive particles, and curing agent are mixed to form the flowable conductive adhesive. The flowable conductive adhesive is just formed by mixing and is loaded in the coating adhesive device and coated on the corresponding areas of the array substrate along a default direction such as the direction parallel to a scan line or a data line

Further, the step S102 is particular to move the coating adhesive device along the default direction and coat the flowable conductive adhesive on the array substrate.

Or, the step S102 particular includes moving the array substrate along a direction opposite to the default direction and coating the flowable conductive adhesive on the array substrate.

In an embodiment of the present application, it can move the array substrate or the coating adhesive device to coat the flowable conductive adhesive on a position of the array substrate where needs the flowable conductive adhesive.

S103: curing the flowable conductive adhesive coated on the array substrate by ultraviolet.

The flowable conductive adhesive needs to be cured after coating it on the array substrate so it can perform adhesion between the array substrate and the driver IC of LCD. Ultraviolet can cure the flowable conductive adhesive.

Ultraviolet can be hanged on a position above the array substrate and right facing areas of the array substrate needs the conductive adhesive.

In an embodiment of the present application, ultraviolet can cure the flowable conductive adhesive. It can adopt other methods to cure the flowable conductive adhesive coated on the array substrate as well. As long as these methods can cure the flowable conductive adhesive.

The method of coating a conductive adhesive on an array substrate in accordance with this embodiment of the present application does not form the conventional conductive adhesive which undergoes the processes such as dispensing and packaging, cutting, packing, and transportation in the market. It does not adhere the conventional conductive adhesive on the array substrate but directly coats the flowable conductive adhesive formed by mixing raw materials on the array substrate. It can reduce many processes and save cost.

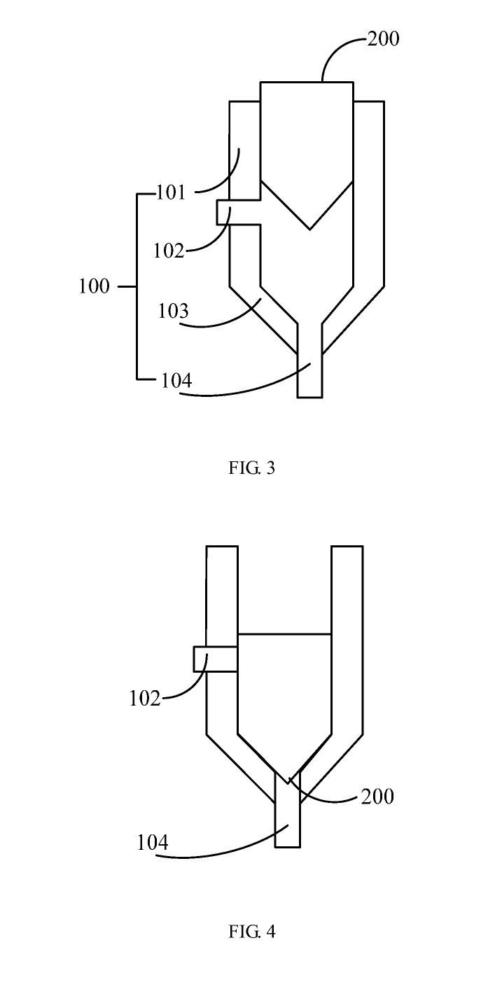

Referring FIG. 3, FIG. 3 is a structure schematic view of a coating adhesive device in accordance with an embodiment of the present application. The coating adhesive device includes a driver device (not shown), a container 100, and a firing pin 200. The container 100 is to carry the flowable conductive adhesive. A lateral wall of the container 100 includes an inlet 102 and a bottom thereof includes an outlet 104. The firing pin 200 is disposed inside the container 100. The firing pin 200 is driven by the driver device to reciprocate between a first position and a second position. The outlet 104 is clogged by the firing pin 200 when the firing pin 200 is at the first position. The firing pin 200 leaves the outlet 104 and the flowable conductive adhesive can flow out when the firing pin 200 is at the second position.

Further, the flowable conductive adhesive can be ACF.

The conventional conductive adhesive such as ACF is processed to be a package by a supplier. The package ACF needs to undergo processes such as glue mixing, dispensing, and cutting, and be packed and transported to the market. Coating adhesive on a display panel generally adopts this package ACF to adhere an array substrate and a driver IC system. This procedure results in that the costs of the ACF and the display panel are high.

The coating adhesive device in accordance with this embodiment of the present application loads the flowable conductive adhesive formed by mixing the raw materials of ACF, and directly coats the conductive adhesive on corresponding areas of the array substrate. The present application does not form the conventional conductive adhesive which undergoes the processes such as dispensing and packaging, but performs coating adhesive through the coating adhesive device. It needs not to adopt every instrument and device for the process of manufacturing the conductive adhesive and saves cost.

The firing pin 200 is driven by the driver device to reciprocate. The driver device controls frequency of up and down movement of the firing pin 200 and dispensing amount of the conductive adhesive.

Referring FIG. 4, the outlet 104 is clogged by the firing pin 200 and the flowable conductive adhesive cannot flow out when the firing pin 200 is at the first position.

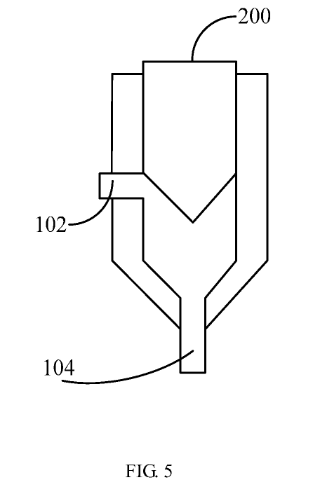

Referring FIG. 5, the firing pin 200 leaves the outlet 104 and the flowable conductive adhesive can flow out when the firing pin 200 is at the second position. The position of the array substrate requiring coating adhesive is right beneath the outlet 104.

Particularly, the second position is the lowest position or the highest position where the firing pin 200 is and the flowable conductive adhesive can flow out the outlet 104. FIG. 5 is merely an embodiment of the present application.

Further, the container 100 includes an upper part 101 and a lower part 103. The upper part 101 is a cylinder shape and the lower part 103 is a funnel shape.

Further, the firing pin 200 includes a column and a needle. The needle is a cone shape.

Further, diameter of the column is equal to that of an inner wall of the upper part 101 of the container 100.

Further, the inlet 102 is located on the upper part 101 of the container 100. A top of the firing pin 200 is higher than the inlet 102 when the firing pin 200 is at the first position.

The top of the firing pin 200 is higher than the inlet 102 when the firing pin 200 is at the first position. It can ensure that the flowable conductive adhesive flow into a space defined by the firing pin 200 and the container 100. The diameter of the column is equal to that of the inner wall of the upper part 101 of the container 100 so the firing pin 200 becomes a seal on the top of the container 100 and prevents the conductive adhesive from contamination.

The diameter of the column is equal to that of the inner wall of the upper part 101 of the container 100. The top of the firing pin 200 is higher than the inlet 102 when the firing pin 200 is at the first position. The conductive adhesive does not flow out the outlet 104 and flow into the inlet 102.

The coating adhesive device in accordance with this embodiment of the present application directly coats the flowable conductive adhesive formed by mixing raw materials on the array substrate. It needs not to adopt the devices for many processes and saves cost.

An embodiment of the present application further provides a coating adhesive system including a moving device and a coating adhesive device.

The moving device is to move the coating adhesive device to coat the flowable conductive adhesive on the array substrate along the default direction.

The moving device is connected with the coating adhesive device and moves it along the default direction, or is to load the array substrate and moves it along a direction opposite to the default direction.

The coating adhesive device includes a driver device, a container, and a firing pin. The container is to carry the flowable conductive adhesive. A lateral wall of the container includes an inlet and a bottom thereof includes an outlet. The firing pin is disposed inside the container. The firing pin is driven by the driver device to reciprocate between a first position and a second position. The outlet is clogged by the firing pin when the firing pin is at the first position. The firing pin leaves the outlet and the flowable conductive adhesive can flow out when the firing pin is at the second position.

The firing pin is driven by the driver device to reciprocate between the first position and the second position. The driver device controls frequency of up and down movement of the firing pin and dispensing amount of the conductive adhesive.

The outlet is clogged by the firing pin and the flowable conductive adhesive cannot flow out when the firing pin is at the first position.

The firing pin leaves the outlet and the flowable conductive adhesive can flow out when the firing pin is at the second position. The position of the array substrate requiring coating adhesive is right beneath the outlet.

Particularly, the second position is the lowest position or the highest position where the firing pin is and the flowable conductive adhesive can flow out the outlet 104.

The container includes an upper part and a lower part. The upper part is a cylinder shape and the lower part is a funnel shape.

The firing pin includes a column and a needle. The needle is a cone shape.

Diameter of the column is equal to that of an inner wall of the upper part of the container.

The inlet is located on the upper part of the container. A top of the firing pin is higher than the inlet when the firing pin is at the first position.

The top of the firing pin is higher than the inlet when the firing pin is at the first position. It can ensure that the flowable conductive adhesive flow into a space defined by the firing pin and the container. The diameter of the column is equal to that of the inner wall of the upper part of the container so the firing pin becomes a seal on the top of the container and prevents the conductive adhesive from contamination.

The diameter of the column is equal to that of the inner wall of the upper part of the container. The top of the firing pin is higher than the inlet when the firing pin is at the first position. The conductive adhesive does not flow out the outlet and flow into the inlet.

The coating adhesive system further includes a curing device. The curing device is to irradiate ultraviolet to the flowable conductive adhesive coated on the array substrate and cures the flowable conductive adhesive.

The coating adhesive device in accordance with this embodiment of the present application directly coats the flowable conductive adhesive formed by mixing raw materials on the array substrate. It needs not to adopt the devices for many processes and saves cost.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. A coating adhesive device, comprising:
a driver device;
a container carrying a flowable conductive adhesive, comprising a lateral wall, an inlet on the lateral wall, a bottom, and an outlet on the bottom; and
a firing pin disposed inside the container, reciprocating between a first position and a second position,
wherein the outlet is clogged by the firing pin when the firing pin is at the first position, and the firing pin leaves the outlet and the flowable conductive adhesive flows out when the firing pin is at the second position.

2. The coating adhesive device of claim 1, wherein the container comprises an upper part and a lower part, and the upper part is a cylinder shape and the lower part is a funnel shape.

3. The coating adhesive device of claim 2, wherein the firing pin comprises a column and a needle, and the needle is a cone shape.

4. The coating adhesive device of claim 3, wherein the upper part comprises an inner wall, and diameter of the column is equal to that of the inner wall.

5. The coating adhesive device of claim 2, wherein the inlet is located on the upper part, and a top of the firing pin is higher than the inlet when the firing pin is at the first position.

6. The coating adhesive device of claim 1, wherein the flowable conductive adhesive from the outlet is coated on an array substrate along a default direction.

7. A coating adhesive system, comprising a moving device and a coating adhesive device, the coating adhesive device comprising:
a driver device;
a container carrying a flowable conductive adhesive, comprising a lateral wall and an inlet on the lateral wall, and a bottom and an outlet on the bottom; and
a firing pin disposed inside the container, reciprocating between a first position and a second position, wherein the outlet is clogged by the firing pin when the firing pin is at the first position, and the firing pin leaves the outlet and the flowable conductive adhesive flows out when the firing pin is at the second position;
wherein the moving device moves the coating adhesive device to coat the flowable conductive adhesive on an array substrate along a default direction.

8. The coating adhesive system of claim 7, wherein the container comprises an upper part and a lower part, and the upper part is a cylinder shape and the lower part is a funnel shape.

9. The coating adhesive system of claim 8, wherein the firing pin comprises a column and a needle, and the needle is a cone shape.

10. The coating adhesive system of claim 9, wherein the upper part comprises an inner wall, and diameter of the column is equal to that of the inner wall.

11. The coating adhesive system of claim 8, wherein the inlet is located on the upper part, and a top of the firing pin is higher than the inlet when the firing pin is at the first position.

12. The coating adhesive system of claim 7, wherein the flowable conductive adhesive from the outlet is coated on the array substrate along the default direction

13. The coating adhesive system of claim 7, wherein the moving device is connected with the coating adhesive device and moves the coating adhesive device along the default direction.

14. The coating adhesive system of claim 7, wherein the moving device loads the array substrate and moves the array substrate along a direction opposite to the default direction.

15. The coating adhesive system of claim 7, further comprising a curing device, wherein the curing device irradiates ultraviolet to the flowable conductive adhesive coated on the array substrate and cures the flowable conductive adhesive.

16. A method of coating a conductive adhesive on an array substrate, comprising:
loading a flowable conductive adhesive in a coating adhesive device; and
pressing the flowable conductive adhesive from the coating adhesive device and coating the flowable conductive adhesive on the array substrate along a default direction.

17. The method of claim 16, after pressing the flowable conductive adhesive from the coating adhesive device and coating the flowable conductive adhesive along a default direction, further comprising curing the flowable conductive adhesive coated on the array substrate.

18. The method of claim 17, wherein curing the flowable conductive adhesive coated on the array substrate comprises curing the flowable conductive adhesive coated on the array substrate by ultraviolet.

19. The method of claim 16, wherein coating the flowable conductive adhesive on the array substrate along the default direction comprises moving the coating adhesive device along the default direction and coating the flowable conductive adhesive on the array substrate.

20. The method of claim 16, wherein coating the flowable conductive adhesive on the array substrate along the default direction comprises moving the array substrate along a direction opposite to the default direction and coating the flowable conductive adhesive on the array substrate.
